(19) United States
(12) Patent Application Publication
(10) Pub. No.: US 2016/0202790 A1
(43) Pub. Date: Jul. 14, 2016

(54) SELF-CAPACITIVE TOUCH PANEL, DRIVING METHOD FOR THE SAME, AND TOUCH DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Shengji YANG, Beijing (CN); Xue DONG, Beijing (CN); Haisheng WANG, Beijing (CN); Weijie ZHAO, Beijing (CN); Yingming LIU, Beijing (CN); Jingbo XU, Beijing (CN); Xiangyan ZHANG, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 14/799,251

(22) Filed: Jul. 14, 2015

(30) Foreign Application Priority Data
Jan. 14, 2015 (CN) 201510018468.8

(51) Int. Cl. G06F 3/044; G06F 3/041

(52) U.S. Cl. CPC G06F 3/044; G06F 3/0412; G06F 2203/04112

(57) ABSTRACT

The present disclosure provides in an embodiment a self-capacitive touch panel, including: switching units; and touch electrodes which are arranged in a matrix form and in a plurality of rows and a plurality of columns. Each touch electrode in at least one row of the touch electrodes may be connected to a touch electrode in a same column but in another row of the touch electrodes through a corresponding switching unit; and the switching units may be configured to control corresponding touch signals to be inputted into the touch electrodes in the plurality of rows in a time-division manner in a touch time period; or each touch electrode in at least one column of the touch electrodes may be connected to a touch electrode in a same row but in another column of the touch electrodes through a corresponding switching unit; and the switching units may be configured to control corresponding touch signals to be inputted into the touch electrodes in the plurality of columns in a time-division manner in the touch time period.

### CROSS-REFERENCE TO RELATED APPLICATION

The present application claims a priority of the Chinese patent application No. 201510018468.8 filed on Jan. 14, 2015, which is incorporated herein by reference in its entirety.

### TECHNICAL FIELD

The present disclosure relates to a touch display technology, in particular to a self-capacitive touch panel, its driving method and a touch display device.

### BACKGROUND

Currently, a self-capacitive touch mode has been widely used in the field of display devices. However, on the premise of ensuring a touch resolution, a size of a certain touch electrode is restricted. In an existing in-cell self-capacitive touch panel, most of the touch electrodes use a Block Pattern design. In the in-cell self-capacitive touch panel, a large number of touch electrodes are needed. However, in the related art, each touch electrode and a corresponding touch signal line are connected by a separate channel. Thus, a large number of channels between the touch electrodes and touch signal lines are needed as well. As a result, design requirements of narrow-border products cannot be met, and cost and size of the in-cell self-capacitive touch panel is increased.

### SUMMARY

An object of the present disclosure is to provide a self-capacitive touch panel, its driving method and a touch display device, so as to solve the problem in the related art that a large number of channels between the touch electrodes and touch signal lines are needed, so that design requirements of narrow-border products cannot be met, and cost and size of the in-cell self-capacitive touch panel is increased.

Therefore, the present disclosure provides in an embodiment a self-capacitive touch panel, including: switching units; and touch electrodes which are arranged in a matrix form and in a plurality of rows and a plurality of columns. Each touch electrode in at least one row of the touch electrodes may be connected to a touch electrode in a same column but in another row of the touch electrodes through a corresponding switching unit; and the switching units may be configured to control corresponding touch signals to be inputted into the touch electrodes in the plurality of rows in a time-division manner in a touch time period. Or each touch electrode in at least one column of the touch electrodes may be connected to a touch electrode in a same row but in another column of the touch electrodes through a corresponding switching unit; and the switching units may be configured to control corresponding touch signals to be inputted into the touch electrodes in the plurality of columns in a time-division manner in the touch time period.

Alternatively, the self-capacitive touch panel may further include: a source electrode; and a gate electrode. In the touch time period, the touch signals may be inputted into both the source electrode and the gate electrode.

Alternatively, in a display time period, a common electrode signal may be inputted into the touch electrodes in the plurality of rows and in the plurality of columns.

Alternatively, the switching units may be arranged within an active display region.

Alternatively, the switching units may include a plurality of first switch transistors and a plurality of second switch transistors; and when each touch electrode in at least one row of the touch electrodes is connected to the touch electrode in the same column but in another row of the touch electrodes through the corresponding switching unit, one of the first switch transistors may be connected between each touch electrode in the at least one row of touch electrodes and a corresponding touch signal line, a first scanning signal may be inputted into a gate electrode of the first switch transistor; and one of the second switch transistors may be connected between the touch electrode in the same column but in another row of the touch electrodes and a corresponding touch signal line, a second scanning signal may be inputted into a gate electrode of the second switch transistor.

Alternatively, the switching units may include a plurality of first switch transistors and a plurality of second switch transistors; and when each touch electrode in at least one column of the touch electrodes is connected to the touch electrode in the same row but in another column of the touch electrodes through the corresponding switching unit, one of the first switch transistors may be connected between each touch electrode in the at least one column of touch electrodes and a corresponding touch signal line, a first scanning signal may be inputted into a gate electrode of the first switch transistor; and one of the second switch transistors may be connected between the touch electrode in the same row but in another column of the touch electrodes and a corresponding touch signal line, a second scanning signal may be inputted into a gate electrode of the second switch transistor.

In another aspect, the present disclosure provides in an embodiment a method for driving a self-capacitive touch panel, the self-capacitive touch panel including switching units and touch electrodes which are arranged in a matrix form and in a plurality of rows and a plurality of columns, the driving method including: controlling, in a touch time period, by the switching units, corresponding touch signals to be inputted into the touch electrodes in the plurality of rows in a time-division manner, when each touch electrode in at least one row of the touch electrodes is connected to a touch electrode in a same column but in another row of the touch electrodes through a corresponding switching unit; or controlling, in the touch time period, by the switching units, corresponding touch signals to be inputted into the touch electrodes in the plurality of columns in a time-division manner, when each touch electrode in at least one column of the touch electrodes is connected to a touch electrode in a same row but in another column of the touch electrodes through a corresponding switching unit.

Alternatively, a common electrode signal may be inputted into all of the touch electrodes in the plurality of rows and in the plurality of columns within the self-capacitive touch panel.

In still another aspect, the present disclosure provides in an embodiment a touch display device, including the above self-capacitive touch panel.

Compared to the related art, in the self-capacitive touch panel, the driving method and the touch display device according to the present disclosure, the number of channels between touch electrodes and corresponding touch signal lines can be reduced while a touch location can be determined, thereby decreasing the cost and size of the in-cell self-capacitive touch panel and conducing to a narrow-border design.

### BRIEF DESCRIPTION OF THE DRAWINGS

In order to more clearly illustrate the technical solutions according to the embodiments of the present disclosure or the related art, accompany drawings acquired to use in the description of the embodiments will be described briefly below. It is obvious that, the described drawings are merely parts of embodiments of the present disclosure, and other drawings can also be obtained according to these drawings for a person skilled in the art without creative work.

FIG. 1 is a schematic diagram showing a structure of a self-capacitive touch panel according to an embodiment of the present disclosure;

FIG. 2 is a circuit diagram of a switching unit included in a self-capacitive touch panel according to an embodiment of the present disclosure; and

FIG. 3 is a time sequence diagram in a touch time period for a self-capacitive touch panel according to an embodiment of the present disclosure.

### DETAILED DESCRIPTION

Embodiments of the present disclosure will be further described below in conjunction with the accompanying drawings and examples. The following embodiments are merely used to illustrate the present disclosure, but not intended to limit the scope of the present invention.

In order to make the objects, technical solutions and advantages of the embodiments of the present disclosure more clear, the technical solutions according to the embodiments of the present disclosure will be clearly and fully described hereinafter in conjunction with the accompanying drawings in the embodiments of the present disclosure. Obviously, the described embodiments are merely parts of embodiments of the present disclosure, but not all the embodiments. Based on the embodiments in the present disclosure, all the other embodiments obtained by a person skilled in the art will fall within the protection scope of the present disclosure.

Unless otherwise defined, technical terms or scientific terms used herein shall have the general meaning which can be understood by a person skilled in the art. The terms “first”, “second” or the like used in the specification and claims of the present disclosure do not denote any sequence, quantity, or importance, but rather are used to distinguish different components. Similarly, the terms “a” or “an” or the like do not mean quantitative restrictions, but rather indicate the presence of at least one. The terms “connect” or “couple” or the like are not limited to connect physically or mechanically, but may include connecting electrically either directly or indirectly. The terms “up”, “down”, “left”, “right”, etc., are merely used to indicate a relative positional relationship; when the absolute position of the described object is changed, the relative positional relationship is changed correspondingly.

The present disclosure provides in an embodiment a self-capacitive touch panel, including switching units and touch electrodes which are arranged in a matrix form and in a plurality of rows and a plurality of columns,

wherein each touch electrode in at least one row of the touch electrodes is connected to a touch electrode in a same column but in another row of the touch electrodes through a corresponding switching unit; and the switching units are configured to control corresponding touch signals to be inputted into the touch electrodes in the plurality of rows in a time-division manner in a touch time period; or

wherein each touch electrode in at least one column of the touch electrodes is connected to a touch electrode in a same row but in another column of the touch electrodes through a corresponding switching unit; and the switching units are configured to control corresponding touch signals to be inputted into the touch electrodes in the plurality of columns in a time-division manner in the touch time period.

In the self-capacitive touch panel according to an embodiment of the present disclosure, each touch electrode in at least one row of the touch electrodes is connected to a touch electrode in a same column but in another row of the touch electrodes through a corresponding switching unit; the switching units are configured to control corresponding touch signals to be inputted into the touch electrodes in the plurality of rows in a time-division manner in a touch time period; and touch signals will not be inputted into the touch electrodes in the plurality of rows connected by the switching units simultaneously; or each touch electrode in at least one column of the touch electrodes is connected to a touch electrode in a same row but in another column of the touch electrodes through a corresponding switching unit; and touch signals will not be inputted into the touch electrodes in the plurality of columns connected by the switching units simultaneously. Therefore, for the self-capacitive touch panel according to embodiments of the present disclosure, the number of channels between touch electrodes and corresponding touch signal lines can be reduced while a touch location can be determined precisely, thereby decreasing the cost and size of the in-cell self-capacitive touch panel and conducing to a narrow-border design.

Next, a self-capacitive touch panel according to an embodiment of the present disclosure will be described in conjunction with embodiments and the accompanying drawings.

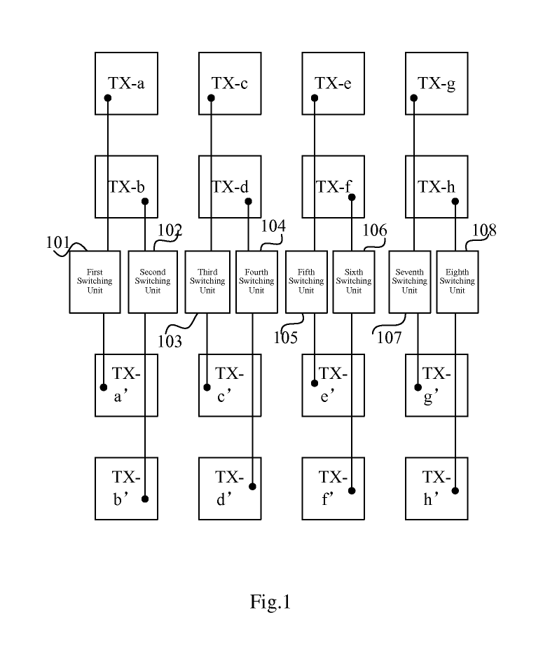

As shown in FIG. 1, the self-capacitive touch panel includes eight switching units and touch electrodes which are arranged in a matrix form and in four (4) rows and four (4) columns.

The eight switching units are a first switching unit 101, a second switching unit 102, a third switching unit 103, a fourth switching unit 104, a fifth switching unit 105, a sixth switching unit 106, a seventh switching unit 107 and an eighth switching unit 108, respectively.

A touch electrode TX-a in a first row and a first column and a touch electrode TX-a′ in a third row and the first column are connected to each other through the first switching unit 101.

A touch electrode TX-b in a second row and the first column and a touch electrode TX-b′ in a fourth row and the first column are connected to each other through the second switching unit 102.

A touch electrode TX-c in the first row and a second column and a touch electrode TX-c′ in the third row and the second column are connected to each other through the third switching unit 103.

A touch electrode TX-d in the second row and the second column and a touch electrode TX-d′ in the fourth row and the second column are connected to each other through the fourth switching unit 104.

A touch electrode TX-e in the first row and a third column and a touch electrode TX-e′ in the third row and the third column are connected to each other through the fifth switching unit 105.

A touch electrode TX-f in the second row and the third column and a touch electrode TX-f′ in the fourth row and the third column are connected to each other through the sixth switching unit 106.

A touch electrode TX-g in the first row and a fourth column and a touch electrode TX-g′ in the third row and the fourth column are connected to each other through the seventh switching unit 107.

A touch electrode TX-h in the second row and the fourth column and a touch electrode TX-h′ in the fourth row and the fourth column are connected to each other through the eighth switching unit 108.

The first switching unit 101, into which a first scanning signal and a second scanning signal (not shown in FIG. 1) are inputted, is configured to control, in a touch time period, a first touch signal TX1 to be inputted into the touch electrode TX-a in the first row and the first column or the touch electrode TX-a′ in the third row and the first column according to the first scanning signal and the second scanning signal.

The second switching unit 102, into which a third scanning signal and a fourth scanning signal (not shown in FIG. 1) is inputted, is configured to control, in the touch time period, a second touch signal TX2 to be inputted into the touch electrode TX-b in the second row and the first column or the touch electrode TX-b′ in the fourth row and the first column according to the third scanning signal and the fourth scanning signal.

The third switching unit 103, into which the first scanning signal and the second scanning signal (not shown in FIG. 1) is inputted, is configured to control, in the touch time period, the first touch signal TX1 to be inputted into the touch electrode TX-c in the first row and the second column or the touch electrode TX-c′ in the third row and the second column according to the first scanning signal and the second scanning signal.

The fourth switching unit 104, into which the third scanning signal and the fourth scanning signal (not shown in FIG. 1) is inputted, is configured to control, in the touch time period, a second touch signal TX2 to be inputted into the touch electrode TX-d in the second row and the second column or the touch electrode TX-d′ in the fourth row and the second column according to the third scanning signal and the fourth scanning signal.

The fifth switching unit 105, into which the first scanning signal and the second scanning signal (not shown in FIG. 1) is inputted, is configured to control, in the touch time period, the first touch signal TX1 to be inputted into the touch electrode TX-e in the first row and the third column or the touch electrode TX-e′ in the third row and the third column according to the first scanning signal and the second scanning signal.

The sixth switching unit 106, into which the third scanning signal and the fourth scanning signal (not shown in FIG. 1) is inputted, is configured to control, in the touch time period, a second touch signal TX2 to be inputted into the touch electrode TX-f in the second row and the third column or the touch electrode TX-f′ in the fourth row and the third column according to the third scanning signal and the fourth scanning signal.

The seventh switching unit 107, into which the first scanning signal and the second scanning signal (not shown in FIG. 1) is inputted, is configured to control, in the touch time period, the first touch signal TX1 to be inputted into the touch electrode TX-g in the first row and the fourth column or the touch electrode TX-g′ in the third row and the fourth column according to the first scanning signal and the second scanning signal.

The eighth switching unit 108, into which the third scanning signal and the fourth scanning signal (not shown in FIG. 1) is inputted, is configured to control, in the touch time period, a second touch signal TX2 to be inputted into the touch electrode TX-h in the second row and the fourth column or the touch electrode TX-h′ in the fourth row and the fourth column according to the third scanning signal and the fourth scanning signal.

Alternatively, the first touch signal TX1 is transmitted via a first touch signal line, the second touch signal TX2 is transmitted via a second touch signal line.

The first scanning signal is transmitted via a first scanning line, the second scanning signal is transmitted via a second scanning line, the third scanning signal is transmitted via a third scanning line and the fourth scanning signal is transmitted via a fourth scanning line.

The first touch signal line and the second touch signal line may be arranged to be parallel with a gate line while the first scanning line, the second scanning line, the third scanning line and the fourth scanning line may be arranged to be parallel with a data line. And in order to facilitate an arrangement of lines, all of the switching units may be arranged within an active display region as needed.

When being implemented, the switching units may also be connected between the touch electrodes in adjacent rows and the switching units can control corresponding touch signals to be inputted into the touch electrodes in different rows in the touch time period in a time-division manner. In this way, the number of channels between the touch electrodes and corresponding touch signal lines can be reduced.

When being implemented, the switching units may also be connected between the touch electrodes in adjacent columns. At this time, it is needed to scan the touch electrodes on a column-by-column basis by the scanning signal. Touch electrodes in a same column is inputted with a same corresponding touch signal when they are scanned. In this way, the object of reducing the number of channels between the touch electrodes and the corresponding touch signal lines can also be achieved.

When being implemented, the self-capacitive touch panel may include ouch electrodes which are arranged in a matrix form and in nine (9) rows and nine (9) columns. In this case, each touch electrode in the first row of the touch electrodes, a touch electrode in a same column but in the fourth row of the touch electrodes, and a touch electrode in a same column but in the seventh row of the touch electrodes may be connected through a corresponding switching unit; each touch electrode in the second row of the touch electrodes, a touch electrode in a same column but in the fifth row of the touch electrodes, and a touch electrode in a same column but in the eighth row of the touch electrodes may be connected through a corresponding switching unit; each touch electrode in the third row of the touch electrodes, a touch electrode in a same column but in the sixth row of the touch electrodes, and a touch electrode in a same column but in the ninth row of the touch electrodes may be connected through a corresponding switching unit. And the switching units are configured to control corresponding touch signals to be inputted into the touch electrodes in the plurality of rows in a time-division manner in the touch time period. Therefore, the number of the channels between the touch electrodes and the touch signal lines can be reduced while the touch locations can be determined precisely.

Alternatively, a multiplexed common electrode functions as a touch electrode, that is, in the touch time period, as a touch electrode, the common electrode is inputted with touch signals, while in a display time period, a common electrode signal is inputted into the touch electrodes which are arranged in a matrix form and in the plurality of rows and the plurality of columns to achieve a display function. This can be achieved by adopting a time-division driving method where a touch mode and a display mode alternate (detailed description of the method will be discussed later). In this way, an arrangement of additional touch electrodes is not needed; the multiplexed common electrode can function as a touch electrode by using the time-division driving method, which can save cost and space.

When being implemented, the self-capacitive touch panel may further include a source electrode and a gate electrode. In the touch time period, in order to eliminate adverse impact on a gate-source capacitor caused by the touch electrodes, the touch signal is inputted into both the source electrode and the gate electrode.

Alternatively, the switching units may include a plurality of first switch transistors and a plurality of second switch transistors. When each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

Alternatively, the switching units may include a plurality of first switch transistors and a plurality of second switch transistors. When each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.

Next, a specific structure of the switching unit will be described by taking a first switching unit 101 and a second switching unit 102 applied in the self-capacitive touch panel as shown in FIG. 1 as example.

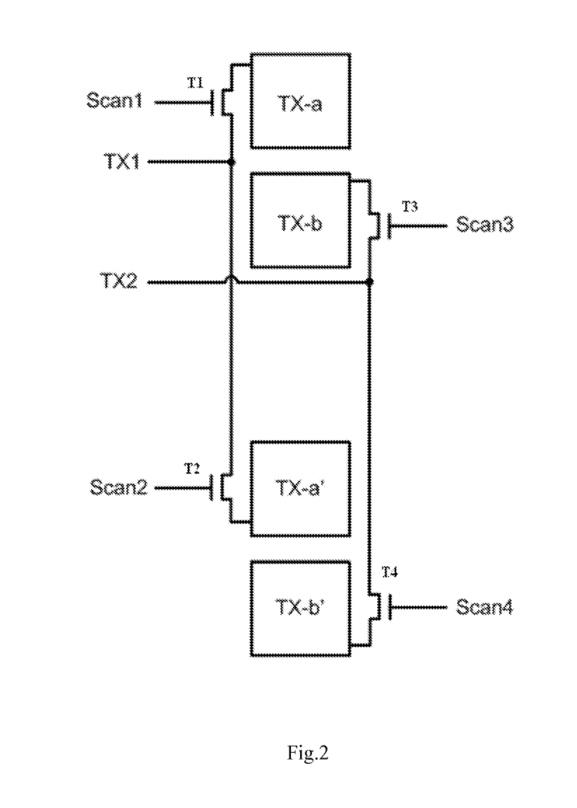

Alternatively, as shown in FIG. 2, the first switching unit 101 may include a first transistor T1 and a second transistor T2. For the first transistor T1, a first scanning signal Scan1 is inputted into a gate electrode, a first electrode is connected to the touch electrode TX-a in the first row and the first column included in a first touch electrode unit, and a first touch signal TX1 is inputted into a second electrode. And for the second transistor T2, a second scanning signal Scan2 is inputted into a gate electrode, the first touch signal TX1 is inputted into a first electrode, and a second electrode is connected to the touch electrode TX-a′ in the third row and the first column.

The second switching unit 102 may include a third transistor T3 and a fourth transistor T4. For the third transistor T3, a third scanning signal Scan3 is inputted into a gate electrode, a first electrode is connected to the touch electrode TX-b in the second row and the first column, and a second touch signal TX2 is inputted into a second electrode. For the fourth transistor T4, a fourth scanning signal Scan4 is inputted into a gate electrode, the second touch signal TX2 is inputted into a first electrode, and a second electrode is connected to the touch electrode TX-b′ in the fourth row and the first column.

In the embodiment as shown in FIG. 2, T1, T2, T3 and T4 are all of N-type transistors (When being implemented, T1, T2, T3 and T4 may be all of P-type transistors).

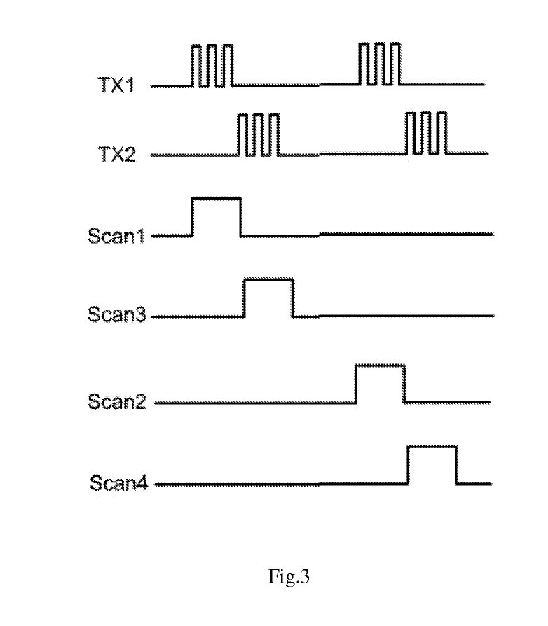

As shown in FIG. 3, in the touch time period, when the touch electrode in the first touch electrode unit is working, the first touch signal TX1 is inputted into the first touch signal line, the second touch signal TX2 is inputted into the second touch signal line. And at this time, Scan1 is of a high level, Scan2 is of a low level, Scan3 is of a high level and Scan4 is of a low level. The first touch signal TX1 is inputted into TX-a and the second touch signal TX2 is inputted into TX-b.

When the touch electrode in the second touch electrode unit is working, the first touch signal TX1 is inputted into the first touch signal line, the second touch signal TX2 is inputted into the second touch signal line. And at this time, Scan1 is of a low level, Scan2 is of a high level, Scan3 is of a low level and Scan4 is of a high level. The first touch signal TX1 is inputted into TX-a′ and the second touch signal TX2 is inputted into TX-b′.

In the self-capacitive touch panel according to embodiments of the present disclosure, since switching units are adopted, it can be distinguished that the touch electrode included in which touch electrode unit is touched when a touch is sensed, so that a real touch point can be determined.

The transistors used in the embodiments of the present disclosure may be thin film transistors (TFTs) or field effect transistors (FETs) or components with same characteristics. In the embodiments of the present disclosure, in order to distinguish two electrodes other than a gate electrode of the transistor, a first electrode of them may be called as a source electrode or a drain electrode, and a second electrode of them may be called as a drain electrode or a source electrode. In addition, transistors can be either N-type transistors or P-type transistors based on their characteristics. In the driving circuit according to embodiments of the present disclosure, all of the transistors are described by taking N-type transistors as an example, it is obvious for a person skilled in the art that the transistors can be all of P-type transistors, which will also fall within the scope of the present disclosure.

Another embodiment of the present disclosure further provides a method for driving the above self-capacitive touch panel. The driving method includes:

controlling, in a touch time period, by the switching units, corresponding touch signals to be inputted into the touch electrodes in the plurality of rows in a time-division manner, when each touch electrode in at least one row of the touch electrodes is connected to a touch electrode in a same column but in another row of the touch electrodes through a corresponding switching unit; or

controlling, in the touch time period, by the switching units, corresponding touch signals to be inputted into the touch electrodes in the plurality of columns in a time-division manner, when each touch electrode in at least one column of the touch electrodes is connected to a touch electrode in a same row but in another column of the touch electrodes through a corresponding switching unit.

In the driving method according to the embodiments of the present disclosure, the switching units control corresponding touch signals to be inputted into the touch electrodes in the plurality of rows or in the plurality of columns in a time-division manner. Therefore, it can be distinguished that the touch electrode included in which touch electrode unit is touched when a touch is sensed, so that a real touch point can be determined. Herein, N is a row number of touch electrodes included in each touch electrode unit.

Alternatively, in the display time period, a common electrode signal is inputted into all of the touch electrodes in the plurality of rows and in the plurality of columns within the self-capacitive touch panel.

Moreover, the present disclosure further provides in yet another embodiment a touch display device, including a plurality of rows of the above self-capacitive touch panels.

The above is only preferred embodiments of the present disclosure, it should be noted that several improvements and modifications may be made for a person skilled in the art without departing from the principle of the present disclosure, and also should be considered to fall within the protection scope of the present disclosure.

What is claimed is:

1. A self-capacitive touch panel, comprising:
switching units; and
touch electrodes which are arranged in a matrix form and in a plurality of rows and a plurality of columns,
wherein each touch electrode in at least one row of the touch electrodes is connected to a touch electrode in a same column but in another row of the touch electrodes through a corresponding switching unit; and the switching units are configured to control corresponding touch signals to be inputted into the touch electrodes in the plurality of rows in a time-division manner in a touch time period; or
wherein each touch electrode in at least one column of the touch electrodes is connected to a touch electrode in a same row but in another column of the touch electrodes through a corresponding switching unit; and the switching units are configured to control corresponding touch signals to be inputted into the touch electrodes in the plurality of columns in a time-division manner in the touch time period.

2. The self-capacitive touch panel according to claim 1, further comprising:
a source electrode; and
a gate electrode,
wherein in the touch time period, the touch signals are inputted into both the source electrode and the gate electrode.

3. The self-capacitive touch panel according to claim 1, wherein in a display time period, a common electrode signal is inputted into the touch electrodes in the plurality of rows and in the plurality of columns.

4. The self-capacitive touch panel according to claim 1, wherein the switching units are arranged within an active display region.

5. The self-capacitive touch panel according to claim 1, wherein
the switching units include a plurality of first switch transistors and a plurality of second switch transistors; and
when each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

6. The self-capacitive touch panel according to claim 2, wherein
the switching units include a plurality of first switch transistors and a plurality of second switch transistors; and
when each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

7. The self-capacitive touch panel according to claim 1, wherein
the switching units include a plurality of first switch transistors and a plurality of second switch transistors; and
when each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.

8. The self-capacitive touch panel according to claim 2, wherein
the switching units include a plurality of first switch transistors and a plurality of second switch transistors; and
when each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.

9. A touch display device, comprising:
a self-capacitive touch panel;
wherein the self-capacitive touch panel comprises:
switching units; and
touch electrodes which are arranged in a matrix form and in a plurality of rows and a plurality of columns,
wherein each touch electrode in at least one row of the touch electrodes is connected to a touch electrode in a same column but in another row of the touch electrodes through a corresponding switching unit; and the switching units are configured to control corresponding touch signals to be inputted into the touch electrodes in the plurality of rows in a time-division manner in a touch time period; or
wherein each touch electrode in at least one column of the touch electrodes is connected to a touch electrode in a same row but in another column of the touch electrodes through a corresponding switching unit; and the switching units are configured to control corresponding touch signals to be inputted into the touch electrodes in the plurality of columns in a time-division manner in the touch time period.

10. The touch display device according to claim 9, wherein the self-capacitive touch panel further comprises:
a source electrode; and
a gate electrode,
wherein in the touch time period, the touch signals are inputted into both the source electrode and the gate electrode.

11. The touch display device according to claim 9, wherein in a display time period, a common electrode signal is inputted into the touch electrodes in the plurality of rows and in the plurality of columns.

12. The touch display device according to claim 9, wherein the switching units are arranged within an active display region.

13. The touch display device according to claim 9, wherein
the switching units include a plurality of first switch transistors and a plurality of second switch transistors; and
when each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

14. The touch display device according to claim 10, wherein
the switching units include a plurality of first switch transistors and a plurality of second switch transistors; and
when each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

15. The touch display device according to claim 9, wherein
the switching units include a plurality of first switch transistors and a plurality of second switch transistors; and
when each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.

16. The touch display device according to claim 10, wherein
the switching units include a plurality of first switch transistors and a plurality of second switch transistors; and
when each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.

17. A method for driving a self-capacitive touch panel, the self-capacitive touch panel comprising switching units and touch electrodes which are arranged in a matrix form and in a plurality of rows and a plurality of columns,
the driving method comprising:
controlling, in a touch time period, by the switching units, corresponding touch signals to be inputted into the touch electrodes in the plurality of rows in a time-division manner, when each touch electrode in at least one row of the touch electrodes is connected to a touch electrode in a same column but in another row of the touch electrodes through a corresponding switching unit; or
controlling, in the touch time period, by the switching units, corresponding touch signals to be inputted into the touch electrodes in the plurality of columns in a time-division manner, when each touch electrode in at least one column of the touch electrodes is connected to a touch electrode in a same row but in another column of the touch electrodes through a corresponding switching unit.

18. The method according to claim 17, wherein in a display time period, a common electrode signal is inputted into all of the touch electrodes in the plurality of rows and in the plurality of columns within the self-capacitive touch panel.

19. The method according to claim 17, wherein
the switching units include a plurality of first switch transistors and a plurality of second switch transistors; and
when each touch electrode in at least one row of the touch electrodes is connected to the touch electrode in the same column but in another row of the touch electrodes through the corresponding switching unit, one of the first switch transistors is connected between each touch electrode in the at least one row of touch electrodes and a corresponding touch signal line, a first scanning signal is inputted into a gate electrode of the first switch transistor; and one of the second switch transistors is connected between the touch electrode in the same column but in another row of the touch electrodes and a corresponding touch signal line, a second scanning signal is inputted into a gate electrode of the second switch transistor.

20. The method according to claim 17, wherein
the switching units include a plurality of first switch transistors and a plurality of second switch transistors; and
when each touch electrode in at least one column of the touch electrodes is connected to the touch electrode in the same row but in another column of the touch electrodes through the corresponding switching unit, one of the first switch transistors is connected between each touch electrode in the at least one column of touch electrodes and a corresponding touch signal line, a first scanning signal is inputted into a gate electrode of the first switch transistor; and one of the second switch transistors is connected between the touch electrode in the same row but in another column of the touch electrodes and a corresponding touch signal line, a second scanning signal is inputted into a gate electrode of the second switch transistor.
